(19) United States
(12) Patent Application Publication
(10) Pub. No.: US 2010/0107626 A1
(43) Pub. Date: May 6, 2010

(54) Hydraulic variator with adjustable drum plates

(75) Inventors: Bryan Nelson, Lacon, IL (US); Kirat Shah, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/289,696

(22) Filed: Oct. 31, 2008

(51) Int. Cl. F16H 39/14; F16H 39/10

(52) U.S. Cl. 60/491; 60/492

(57) ABSTRACT

A variator is provided having a first shaft rotatable around a first longitudinal axis associated with the first shaft and a second shaft rotatable around a second longitudinal axis associated with the second shaft. The variator also has a pump driven by the first shaft. The pump includes a first plurality of drum sleeves attached to a first drum plate tilted at a first angle relative to the first longitudinal axis. The drum sleeves are positioned to slidingly receive a first plurality of piston members. Each piston member is configured to form a seal substantially perpendicular to an axis of an associated drum sleeve. The seal substantially prevents fluid from leaking out of a chamber formed by the piston member end the drum sleeve. The variator further includes a motor fluidly coupled to the pump and configured to drive the second shaft.

### TECHNICAL FIELD

The present disclosure is directed to a hydraulic variator and, more particularly, to a hydraulic variator with adjustable drum plates.

### BACKGROUND

Machines such as, for example, dozers, loaders, excavators, motor graders, dump trucks, and other types of machinery typically include a hydro-mechanical power transmission system to transfer power, e.g., torque and rotational speed generated by a power source, to one or more connected loads, e.g., one or more components of the machine. Such power transmission systems often include two transmissions operatively connected to a single power source.

One of the two transmissions is typically a fixed ratio transmission configured to convert power into one or more desired power ratios, e.g., one or more desired torque and speed ratios, to operate a connected load. Fixed ratio transmissions usually include one or more discrete gear ratios, through which the power generated by the power source is converted to drive the load in a step-wise manner. The discrete gear ratios are typically manually or automatically selected, via a gear shift, as the load changes.

The other transmission is typically a variable ratio transmission connected in parallel to the fixed ratio transmission. The power output of the variable ratio transmission can be adjusted to selectively complement the discrete power ratios of the fixed gear transmission and provide a continuously variable output of torque and speed ratios. Such a power transmission system is commonly referred to as a “step-less” or continuously variable transmission. The variable ratio transmission often includes a variable output pump drivingly connected to a hydraulic motor, which is operatively connected to the fixed ratio transmission. As such, variations in the pump output affect variations in the hydraulic motor output, which is combined with the discrete power ratios of the fixed ratio transmission to provide a continuously variable output of torque and speed ratios.

One example of a variable ratio transmission can be found in U.S. Pat. No. 5,642,617 (the '617 patent) issued to Larkin et al. The '617 patent discloses a hydrostatic transmission that includes a hydraulic motor driven by a hydraulic pump. The hydraulic motor and pump each include a plurality of pistons respectively associated with a plurality of sleeves. The pump and motor share a single swash plate, which controls the displacement of both the motor and the pump. As the tilt of the swash plate is adjusted, a ratio between the input received by the pump and the output generated by the motor changes, thereby generating a continuously variable output.

Although the hydrostatic transmission disclosed in the '617 patent may generate a continuously variable output, the construction of the piston may limit the efficiency and durability of the transmission. In particular, the fluid seal created by the piston with respect to an associated sleeve, which prevents the fluid from prematurely escaping the associated sleeve, may not be substantially perpendicular to the longitudinal axis of the piston. As such, hydrostatic forces may be unbalanced in both the axial and radial directions. The imbalance of forces in the axial direction may cause some of the pressure energy contained within the fluid to be wasted via frictional losses of a rotor on which the piston is fixed, thereby reducing the efficiency of the energy transfer between the fluid and either the pump or the motor. In addition, the imbalance of forces in the axial direction may exert undesired stresses on the bearings securing the piston to the rotor. Such stresses may reduce the life of the pump or motor and may increase maintenance costs. In addition, a substantial portion of the outer surface of the piston may be in contact with the inner wall of an associated sleeve. As such, the piston may generate substantial frictional losses as it slides relative to the associated sleeve due to the relative high velocity and contact force between the piston and the associated sleeve.

The disclosed system is directed to overcoming one or more of the shortcomings set forth above and/or other shortcomings in the art.

### SUMMARY

In one aspect, the present disclosure is directed toward a variator including a first shaft rotatable around a first longitudinal axis associated with the first shaft and a second shaft rotatable around a second longitudinal axis associated with the second shaft. The variator also includes a pump driven by the first shaft. The pump includes a first plurality of drum sleeves attached to a first drum plate titled at a first angle relative to the first longitudinal axis. The drum sleeves are positioned to slidingly receive a first plurality of piston members. Each piston member is configured to form a seal substantially perpendicular to an axis of an associated drum sleeve. The seal substantially prevents fluid from leaking out of a chamber formed by the piston member and the drum sleeve. The variator further includes a motor fluidly coupled to the pump and configured to drive the second shaft.

In another aspect, the present disclosure is directed toward a variator including a first shaft rotatable around a longitudinal axis of the first shaft and a second shaft rotatable around a longitudinal axis of the second shaft. The variator also includes a pump driven by the first shaft. The pump has a first plurality of drum sleeves attached to a first drum plate and positioned to slidingly receive a first plurality of piston members. Each piston member includes a contacting surface having a substantially frustro-spherical shape. The variator further includes a motor fluidly coupled to the pump and configured to drive the second shaft.

### BRIEF DESCRIPTION OF THE DRAWINGS

FIG. 1 is a diagrammatic illustration of an exemplary disclosed machine;

FIG. 2 is a schematic and diagrammatic illustration of an exemplary disclosed powertrain of the machine of FIG. 1;

FIG. 3 is a schematic illustration of an exemplary hydrostatic transmission of the powertrain of FIG. 2;

FIG. 4 is an exploded view illustration of the hydrostatic transmission of FIG. 3;

FIG. 5 is a diagrammatic illustration of an exemplary piston member and associated drum sleeve of the hydrostatic transmission of FIGS. 3 and 4; and

FIG. 6 is a schematic illustration of another exemplary hydrostatic transmission of the powertrain of FIG. 2.

### DETAILED DESCRIPTION

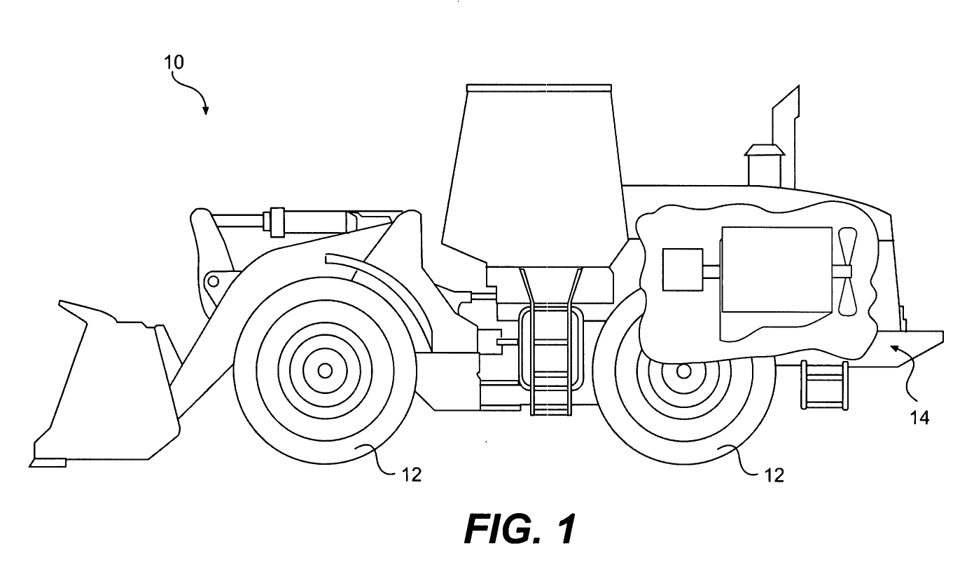

FIG. 1 illustrates an exemplary machine 10 having multiple systems and components that cooperate to accomplish a task. The tasks performed by machine 10 may be associated with a particular industry such as mining, construction, farming, transportation, power generation, or any other industry known in the art. For example, machine 10 may embody a mobile machine such as the wheel loader depicted in FIG. 1, a bus, a highway haul truck, or any other type of mobile machine known in the art. Machine 10 may include one or more traction devices 12 and a powertrain 14 operatively connected to drive at least one of traction devices 12.

Traction devices 12 may embody wheels located on each side of machine 10 (only one side shown). Alternatively, traction devices 12 may include tracks, belts or other known traction devices. It is contemplated that any combination of the wheels on machine 10 may be driven and/or steered.

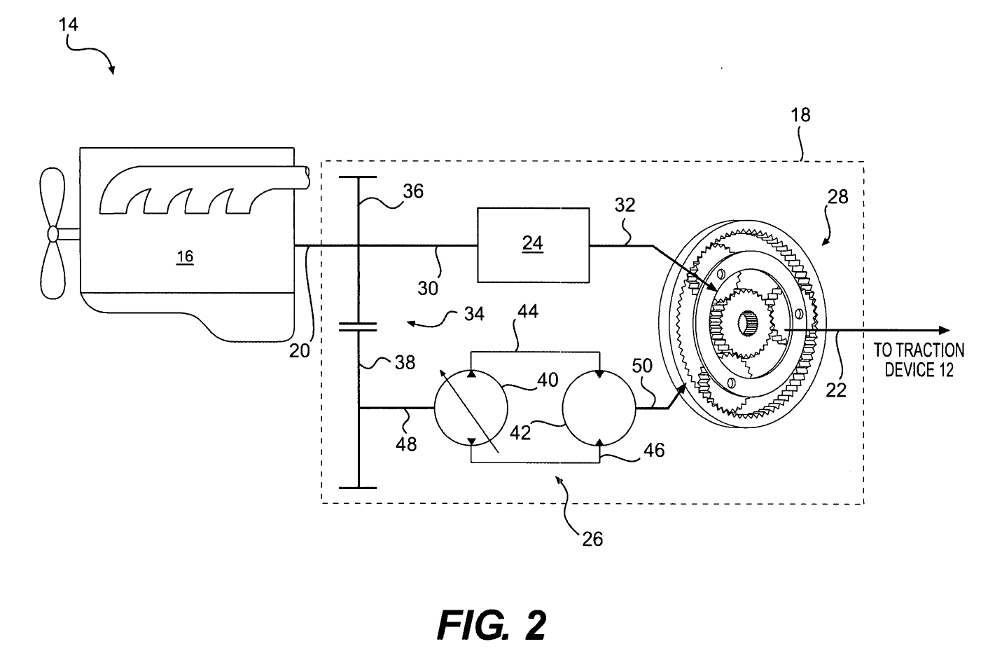

As shown in FIG. 2, powertrain 14 may include components that work together to propel machine 10. Specifically, powertrain 14 may include a power source 16 drivingly coupled to a transmission 18. It is contemplated that powertrain 14 may also include a torque converter (not shown) to couple power source 16 and transmission 18.

Power source 16 may provide power output to transmission 18. Power source 16 may embody an internal combustion engine, such as a diesel engine, a gasoline engine, a gaseous fuel powered engine (e.g., a natural gas engine), or any other type of combustion engine known in the art. Alternatively, power source 16 may embody a non-combustion source of power, such as a fuel cell or a power storage device coupled with an electric motor.

Transmission 18 may be driven by an output shaft 20 of power source 16 and may drive traction devices 12 via a shaft 22. In addition, transmission 18 may include a mechanical portion 24 and a hydrostatic portion 26, the output of which may be combined using one or more gear assemblies 28 (only one shown in FIG. 2) disposed between mechanical and hydrostatic portions 24, 26, and shaft 22. Although gear assembly 28 is illustrated as a planetary gear assembly, it is contemplated that gear assembly 28 may include any other type of gear assembly known in the art capable of combining the outputs of mechanical and hydrostatic portions 24, 26. It is further contemplated that mechanical portion 24 and hydrostatic portion 26 may be connected in parallel (as shown in FIG. 2) or, alternatively, in series.

Mechanical portion 24 may be operationally connected to output shaft 20 of power source 16 via an input shaft 30 and may be operationally connected to gear assembly 28 via a shaft 32. Mechanical portion 24 of transmission 18 may embody, for example, a multi-speed, bidirectional, mechanical transmission with a plurality of forward gear ratios, one or more reverse gear ratios, and one or more clutches. Furthermore, the clutches of mechanical portion 24 may be selectively actuated to engage combinations of gears to produce discrete output gear ratios. Mechanical portion 24 may be an automatic-type transmission, wherein shifting is based on a power source speed, a maximum operator selected gear ratio, and a shift map stored within a controller. Alternatively, mechanical portion 24 may be a manual transmission, wherein the engaged gear is manually selected by an operator. It is contemplated that mechanical portion 24 may include any conventional mechanical, e.g., geared, transmission known in the art.

Hydrostatic portion 26 may receive an input from output shaft 20 of power source 16 via a gear assembly 34, which may include a first gear 36 driven by output shaft 20 and a second gear 38 driven by first gear 36. Hydrostatic portion 26 may include a pump 40 and a motor 42 interconnected by way of a first fluid passage 44 and a second fluid passage 46. Pump 40 may be driven by second gear 38 via an input shaft 48 and may drive motor 42. In addition, motor 42 may be operationally connected to gear assembly 28 via an output shaft 50. A “gear ratio” or “effective gear ratio” of hydrostatic portion 26 may be altered by varying a displacement of pump 40. For example, if pump 40 is a swashplate-type pump, varying the swashplate angle may vary the displacement of the pump, which may in turn vary the output of an associated hydraulic motor as is know in the art. It is contemplated that motor 42 may be a fixed or variable displacement motor. If variable, the “gear ratio” or “effective gear ratio” of hydrostatic portion 26 may be altered by varying the displacement of motor 42. It is also contemplated that within the operational limits of pump 40 and/or motor 42, the fluid displacement of pump 40 and/or motor 42 may be infinitely varied (i.e., any fluid displacement within the operational limits of pump 40 and/or motor 42 may be achievable), thus creating an infinite number of effective gear ratios.

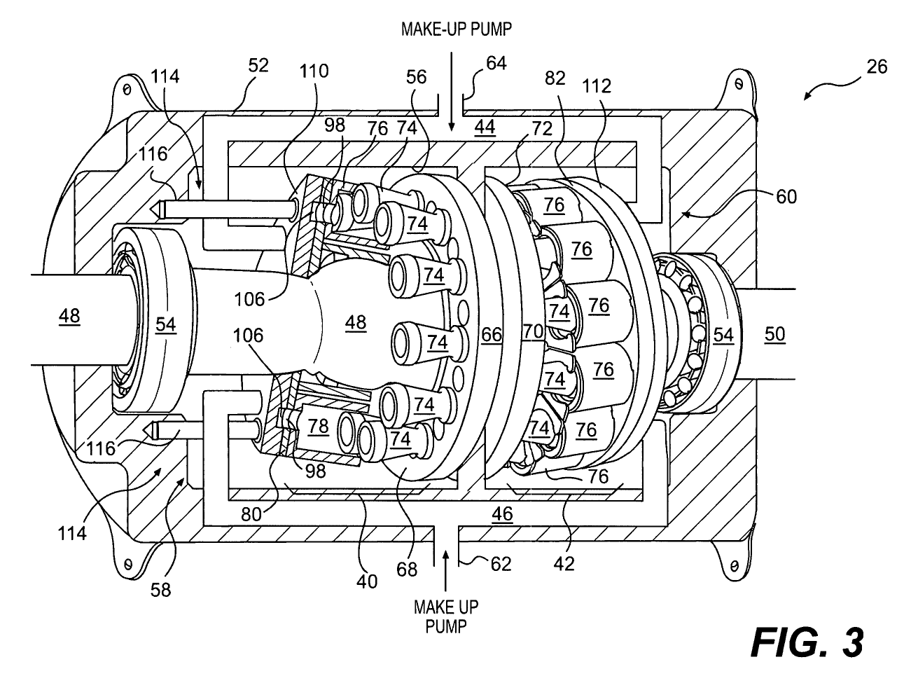

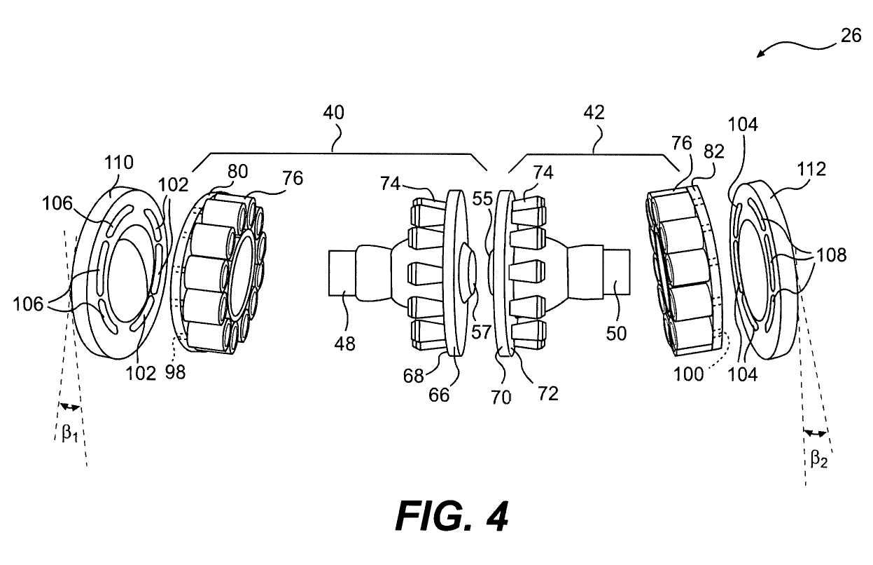

FIGS. 3 and 4 illustrate an exemplary embodiment of hydrostatic portion 26. In particular, hydrostatic portion 26 may include a housing 52 supporting input shaft 48 and output shaft 50 by way of bearings 54. In addition, housing 52 may at least partially contain pump 40 and motor 42. Housing 52 may include a central bore 56 having a first axial end 58 and a second axial end 60. Housing 52 may also contain first and second fluid passages 44, 46 configured to direct fluid between pump 40 and motor 42. For example, pump 40 may be configured to selectively pressurize and direct fluid toward motor 42 via either one of first and second fluid passages 44, 46 and receive fluid from motor 42 via the other one of first and second fluid passages 44, 46. Housing 52 may also include ports 62, 64 in fluid communication with a makeup pump (not shown) for providing makeup fluid to hydrostatic portion 26 and for removing excess fluid circulating within hydrostatic portion 26. It is contemplated that hydrostatic portion 26 may also include one or more makeup valves, e.g., one-way valves or pressure biased valves, respectively disposed between ports 62, 64 and the make-up pump. It is also contemplated that hydrostatic portion 26 may also include a bypass circuit operatively connected to one or both of first and second fluid passages 44, 46 and configured to reduce heat build-up within the circulating fluid.

Input shaft 48 and output shaft 50 may support various components of pump 40 and motor 42, respectively and may be substantially axially aligned with central bore 56. Bearings 54 may engage interior walls of central bore 56 to support the rotation of input shaft 48 and output shaft 50. Input shaft 48 may support a pump rotor 66. Pump rotor 66 may embody a plate-like member fixedly connected to input shaft 48 such that a rotation of input shaft 48 may result in a direct rotation of pump rotor 66. Pump rotor 66 may be integral to input shaft 48 or, alternatively, joined to input shaft 48 through welding, sintering, a keyed or splined joint or other known joining process. In addition, pump rotor 66 may include a face 68 oriented substantially orthogonal to the axial direction of input shaft 48. Output shaft 50 may support a motor rotor 70. Motor rotor 70 may embody a plate-like member fixedly connected to output shaft 50 such that a rotation of output shaft 50 may result in a direct rotation of motor rotor 70. Motor rotor 70 may be integral to output shaft 50 or, alternatively, joined to output shaft 50 through welding, sintering, a keyed or splined joint or other known joining process. In addition, motor rotor 70 may include a face 72 oriented substantially orthogonal to the axial direction of output shaft 50. Pump rotor 66 and motor rotor 70 may be respectively supported relative to housing 26 via shafts 55, 57 (see FIG. 4) and one or more bearings (not shown).

Pump 40 and motor 42 may each include numerous components that interact to direct fluid between first and second fluid passages 44, 46. For example, pump 40 and motor 42 may each include a plurality of piston members 74 respectively connected to faces 68, 72 of pump and motor rotors 66, 70. Pump 40 and motor 42 may also each include a plurality of drum sleeves 76, such that each piston member 74 interacts with a corresponding drum sleeve 76 to form a chamber 78.

Each of drum sleeves 76, associated with piston members 74 extending from face 68, may be connected to a drum plate 80. Each of drum sleeves 76, associated with piston members 74 extending from face 72, may be connected to a drum plate 82. Drum plate 80 may be inclined relative to input shaft 48 and may be configured to rotate therewith. Drum plate 82 may be inclined relative to output shaft 50 and may be configured to rotate therewith. As will be explained in more detail below, the tilt angle of drum plate 80 with respect to input shaft 48 may be adjustable, and the tilt angle of drum plate 82 may or may not be adjustable with respect to output shaft 50. As input shaft 48 and drum plate 80 rotate piston members 74 may move into and out of drum sleeves 76 as a function of the tilt angle thereof, thereby changing the volume of chambers 78. Similarly, as output shaft 50 and drum plate 82 rotate, piston members 74 may move into and out of drum sleeves 76 as a function of the tilt angle thereof, thereby changing the volume of chambers 78.

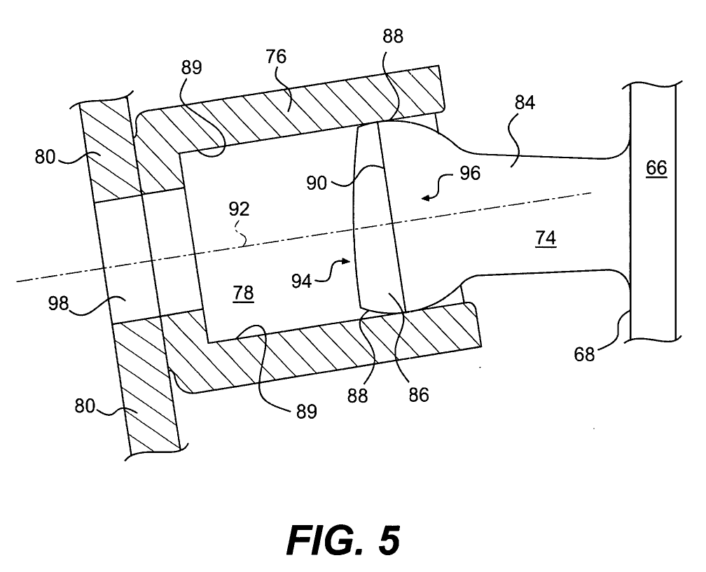

As illustrated in FIG. 5, each piston member 74 may have a body portion 84 for securing piston member 74 to either face 68 of pump rotor 66 (as shown in FIG. 5) or face 72 of motor rotor 70. Body portion 84 may be sized and shaped so that no part of body portion 84 may come into contact with drum sleeve 76 as piston member 74 slides in and out of drum sleeve 76. In addition, body portion 84 may be integral to face 68 of pump rotor 66 (or face 72 of motor rotor 70) or, alternatively, joined to face 68 of pump rotor 66 (or face 72 of motor rotor 70) through welding, sintering, or other known joining process

Each piston member 74 may also have an interfacing portion 86 connected to body portion 84 and having an outer surface 88 in sliding contact with an inner wall 89 of drum sleeve 76. The portion of contact surface 88 interfacing with inner wall 89 may form a seal 90, which may substantially prevent fluid from leaking out of chamber 78 in the direction of pump rotor 66 or motor rotor 70 (see FIGS. 3 and 4). Furthermore, outer surface 88 may be shaped so that seal 90 may be substantially perpendicular to a longitudinal axis 92 of drum sleeve 76 regardless of the position of piston member 74 relative to drum sleeve 76, i.e., regardless of the tilt angle of either drum plate 80 or drum plate 82. For example, outer surface 88 may be substantially shaped like a partial sphere, i.e., may include a substantially frustro-spherical shape. It is contemplated that outer surface 88 may contact inner wall 89 at a line contact, which may minimize frictional forces resulting from the interaction between piston member 74 and an associated drum sleeve 76. It is also contemplated that each piston member 74 may, additionally or alternatively, include a piston ring disposed within interfacing portion 86 and configured to engage inner wall 89 of an associated drum sleeve 76.

FIG. 5 also illustrates an exemplary embodiment of the cross-sectional area of interfacing portion 86. Interfacing portion 86 may have its maximum cross-sectional area at a location between a first end 94 thereof, furthest from body portion 84, and a second end 96 thereof adjacent to body portion 84. It is contemplated that the location of maximum cross-sectional area may be located at a midpoint between first and second ends 94, 96. Body portion 84 may include a relatively larger cross-sectional area at a location adjacent to second end 96 and a relatively smaller cross-sectional area at a location adjacent to plate 68 (as shown in FIG. 5) or plate 70. As such, piston member 74 may only contact an associated drum sleeve 76 within interfacing portion 86.

Referring back to FIGS. 3 and 4, pump 40 and motor 42 may also respectively include face plates 110, 112. Face plate 110 may include a first plurality of distribution passages 102 in fluid communication with first fluid passage 44 and a second plurality of distribution passages 106 in fluid communication with second fluid passage 46. Face plate 112 may include a first plurality of distribution passages 104 in fluid communication with first fluid passage 44 and a second plurality of distribution passages 108 in fluid communication with second fluid passage 46. Face plates 110, 112 may be fixed with respect to the relative rotation of input and output shafts 48, 50 and drum plates 80, 82. As drum plate 80 rotates, distribution holes 98 formed in drum plate 80, may selectively be in fluid communication with the first plurality of distribution passages 102 or the second plurality of distribution passages 106 of face plate 110. As drum plate 82 rotates, distribution holes 100 formed in drum plate 82, may selectively be in fluid communication with the first plurality of passages 104 or the second plurality of distribution passages 108 of face plate 112. It is contemplated that first and second passages 44, 46 may be in fluid communication with approximately half of distribution holes 98, 100 via the respective pluralities of distribution passages 102, 104, 106, 108 at any given rotation of input and output shafts 48, 50.

Drum plates 80, 82 may be inclined with respect to the rotational axes of input and output shafts 48, 50 at respective angles β1, β2. Because of the assembled relationship between face plates 110, 112 (which are fixed with respect to the rotation of input and output shafts 48, 50), drum plates 80, 82 (which rotate with input and output shafts 48, 50), and rotors 66, 70 (which also rotate with input and output shafts 48, 50), piston members 74 may slidingly reciprocate within associated drum sleeves 76. That is, the rotational movement of input shaft 48 and drum plate 80 may cause the volume of chambers 78 associated with pump 40 and motor 42 to selectively increase and decrease as a function of the respective tilt angle of drum plates 80, 82. The increasing volumes may reduce pressure in chambers 78, thereby drawing fluid from one of first or second fluid passages 44, 46 via a plurality of distribution holes 98 in drum plate 80 or a plurality of distribution holes 100 in drum plate 82. The decreasing volumes may increase the pressure in chambers 78 thereby forcing fluid into the other one of first and second fluid passages 44, 46. As such, the respective angles β1, β2 may correspond to the volume change of chambers 78 as is known in the art. Furthermore, angle β1 associated with pump 40 may be different from angle β2 associated with motor 42, such that the volume change of chambers 78 associated with pump 40 during a single revolution of pump rotor 66 may be different than the volume change of chambers 78 associated with motor 42 during a similar revolution of motor rotor 70.

To generate a continuously variable output, the displacement settings of pump 40 may be varied. A variable displacement actuator 114, e.g., a swashplate, may be used to adjust the displacement settings of pump 40. Variable displacement actuator 114 may include components that adjust angle β1 of face plate 110 and subsequently the volume change of chambers 78 associated with pump 40. Specifically, variable displacement actuator 114 may include one or more pistons 116 that may directly or indirectly press against a portion of face plate 110 to urge face plate 110 to tilt relative to the axial direction of input shaft 48. Pistons 116 may be hydraulically actuated, pneumatically actuated, electrically actuated, or actuated in any other known manner such that face plate 110, and thus drum plate 80 and pump rotor 66, may be tilted to a specific desired tilt angle corresponding to a desired characteristic (e.g. flow rate and/or pressure) of the resulting flow of pressurized fluid through first and second fluid passages 44, 46. It is contemplated that angle β2 may or may not be variable and, if so, may similarly include a variable displacement actuator. It is also contemplated that tilt angle β1, may be in a neutral position when perpendicular to the axis of input shaft 48, may be adjusted in a first direction with respect to being perpendicular so as to supply pressurized fluid to first fluid passage 44 and draw pressurized fluid from second fluid passage 46, and may be adjusted in a second direction with respect to being perpendicular to supply pressurized fluid to second fluid passage 46 and draw pressurized fluid from first fluid passage 44.

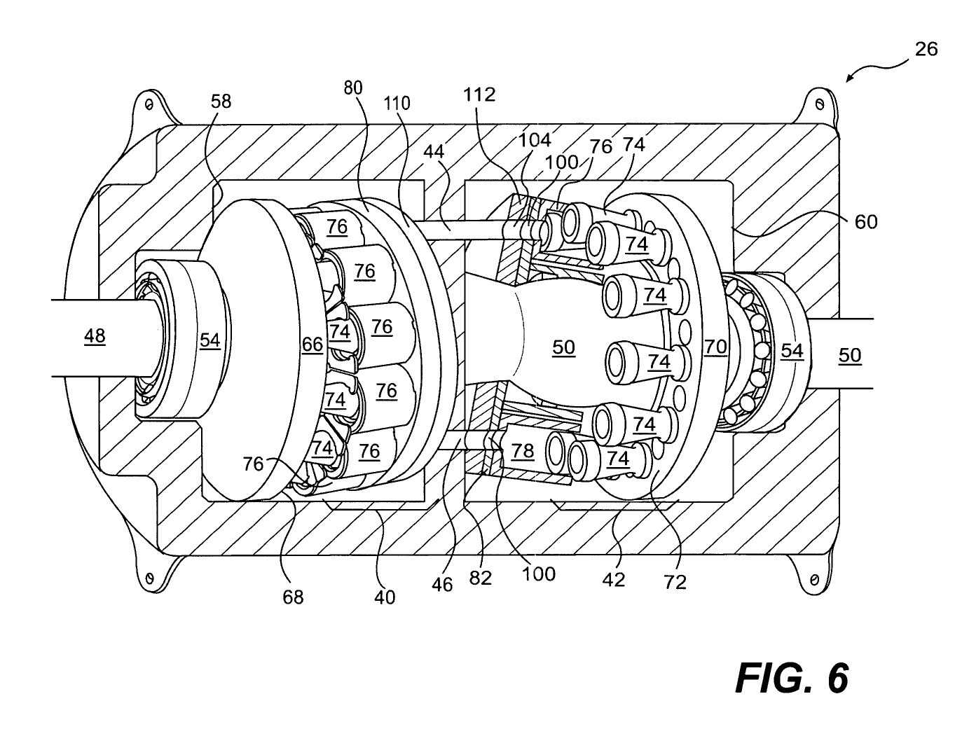

FIG. 6 illustrates another exemplary embodiment of hydrostatic portion 26. The exemplary embodiment illustrated in FIG. 6 may include similar components as the exemplary embodiment illustrated in FIGS. 3 and 4. However, pump rotor 66 and associated piston members 74 may be located at first axial end 58 of housing 52. In addition motor rotor 70 and associated piston members 74 may be located at second axial end 60. Furthermore, drum plates 80, 82 and drum sleeves 76 may be positioned at a central location within housing 52. Such a configuration may reduce the distance between distribution passages 102 and 104 as well as the distance between distribution passages 106 and 108. This may shorten the lengths of first and second fluid passages 44 and 46. The shortened passages may reduce the volume of fluid used by hydrostatic portion 26. In addition, frictional losses associated with first and second fluid passages 44, 46 may be reduced.

### INDUSTRIAL APPLICABILITY

The disclosed hydro-mechanical transmission may be applicable for any type of machine performing operations requiring a continuously variable output from the transmission. In particular, the interaction between piston members 74 and drum sleeves 76 may improve the efficiency and durability of the transmission, thereby increasing the variety of environments and applications in which the transmission may be used.

The interaction between each piston member 74 and an associated drum sleeve 76 may create a fluid seal 90 that is substantially perpendicular to the axis 92 of an associated drum sleeve 76. Such an interaction may substantially prevent the hydrostatic forces in the axial direction thereof from becoming unbalanced, which may minimize the portion of pressure energy wasted as frictional losses by the rotor coupled to the respective piston member. In addition, because the hydrostatic forces in the axial direction may be substantially balanced, stresses acting on the connection between the piston member and the rotor may be minimized. Therefore, the efficiency and durability of the transmission may be increased. Furthermore, minimizing the interface between each piston member and the associated drum sleeve may reduce frictional losses which may further improve the efficiency of the transmission.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A variator, comprising:
a first shaft rotatable around a first longitudinal axis associated with the first shaft;
a second shaft rotatable around a second longitudinal axis associated with the second shaft;
a pump driven by the first shaft and including a first plurality of drum sleeves attached to a first drum plate tilted at a first angle relative to the first longitudinal axis, the drum sleeves being positioned to slidingly receive a first plurality of piston members, each piston member being configured to form a seal substantially perpendicular to an axis of an associated drum sleeve, which substantially prevents fluid from leaking out of a chamber formed by a respective piston member and drum sleeve; and
a motor fluidly coupled to the pump and configured to drive the second shaft.

2. The variator of claim 1, wherein the motor includes a second plurality of drum sleeves attached to a second drum plate tilted at a second angle relative to the second longitudinal axis, the drum sleeves being positioned to slidingly receive a second plurality of piston members, each piston member being configured to form a seal substantially perpendicular to an axis of an associated drum sleeve, which substantially prevents fluid from leaking out of a chamber formed by the piston member and the drum sleeve.

3. The variator of claim 2, wherein the first and second angles are different.

4. The variator of claim 2, wherein the first and second drum plates are positioned at opposite ends of the variator.

5. The variator of claim 2, wherein the first and second drum plates are positioned at a central location within the variator.

6. The variator of claim 1, wherein each piston member has a body portion connecting the piston member to a rotor and an interfacing portion for interfacing with an associated drum sleeve.

7. The variator of claim 1, wherein the largest cross-sectional area of the interfacing portion is located between a first end of the interfacing portion furthest from the body portion and a second end of the interfacing portion nearest the body portion.

8. The variator of claim 7, wherein the largest cross-sectional area of the interfacing portion is located midway between the first and second ends of the interfacing portion.

9. The variator of claim 1, wherein the pump further includes a variable displacement actuator configured to adjust the tilt angle of the first drum plate.

10. A variator, comprising:
a first shaft rotatable around a longitudinal axis of the first shaft;
a second shaft rotatable around a longitudinal axis of the second shaft;
a pump driven by the first shaft and including a first plurality of drum sleeves attached to a first drum plate and positioned to slidingly receive a first plurality of piston members, each piston member including a contacting surface having a substantially frustro-spherical shape;
a motor fluidly coupled to the pump and configured to drive the second shaft.

11. The variator of claim 10, wherein the pump further includes a variable displacement actuator configured to adjust the tilt angle of the first drum plate.

12. The variator of claim 10, wherein the motor includes a second plurality of drum sleeves fixedly attached to a second drum plate and positioned to slidingly receive a second plurality of piston members, each piston member includes a contacting surface having a substantially frustro-spherical shape.

13. The variator of claim 11, wherein the first and second drum plates are positioned at opposite ends of the variator.

14. The variator of claim 11, wherein the first and second drum plates are positioned at a central location within the variator.

15. The variator of claim 11, wherein the first drum plate is tilted at a first angle relative to the longitudinal axis of the first shaft and the second drum plate is tilted at a second angle relative to longitudinal axis of the second shaft.

16. A powertrain, comprising:
a power source; and
a transmission operably connected to the power source, the transmission including:
a first shaft rotatable around a longitudinal axis of the first shaft;
a second shaft rotatable around a longitudinal axis of the second shaft;
a pump driven by the first shaft and including a first plurality of drum sleeves attached to a first drum plate and positioned to slidingly receive a first plurality of piston members, each piston member being configured to form a seal substantially perpendicular to an axis of an associated drum sleeve, which substantially prevents fluid from leaking out of a chamber formed by the piston member and the drum sleeve; and
a motor fluidly coupled to the pump and including a second plurality of drum sleeves attached to a second drum plate and positioned to slidingly receive a second plurality of piston members, each piston member being configured to form a seal substantially perpendicular to an axis of an associated drum sleeve, which substantially prevents fluid from leaking out of a chamber formed by the piston member and the drum sleeve.

17. The powertrain of claim 16, wherein each piston member has a body portion securing the piston member to a rotor and an interfacing portion for interfacing with an associated drum sleeve.

18. The powertrain of claim 17, wherein the largest cross-sectional area of the interfacing portion is located between a first end of the interfacing portion furthest from the body portion and a second end of the interfacing portion nearest the body portion.

19. The powertrain of claim 18, wherein each piston member of the first plurality of piston members includes a contacting surface having a substantially frustro-spherical shape.

20. The powertrain of claim 16, wherein each piston member of the second plurality of piston members includes a contacting surface having a substantially frustro-spherical shape.
